(19) United States
(12) Patent Application Publication
(10) Pub. No.: US 2020/0336581 A1
(43) Pub. Date: Oct. 22, 2020

(54) PERSONAL MOBILE ELECTRONIC DEVICE SUPPORT APPARATUS

(71) Applicant: Quintavious Allen, Rogers, AR (US)

(72) Inventor: Quintavious Allen, Rogers, AR (US)

(21) Appl. No.: 16/852,276

(22) Filed: Apr. 17, 2020

Related U.S. Application Data
(60) Provisional application No. 62/836,137, filed on Apr. 19, 2019.

(51) Int. Cl. H04M 1/04; F16M 11/12; F16M 13/04; F16M 13/02

(52) U.S. Cl. CPC H04M 1/04; F16M 13/022; F16M 13/04; F16M 11/121

(57) ABSTRACT

The present invention is a personal mobile electronic device support apparatus that provides for hands-free viewing, interaction, and interface by a user when seated or reclined.

### CROSS-REFERENCE TO RELATED APPLICATIONS

This application claims the benefit of U.S. Application Ser. No. 62/836,137 filed Apr. 19, 2019, hereby incorporated by reference.

### FIELD OF INVENTION

The present invention relates to a personal mobile electronic device support apparatus adapted for hands-free use with an armed accommodation. More specifically, the present invention provides an apparatus having a stabilizing unit, a plurality of support arms and flexible fastening means configured to support a variety of mobile devices, hands-free, on a plurality of armed accommodations.

### BACKGROUND OF THE INVENTION

Personal mobile electronic devices (PMED) have increasingly become important in daily life. These devices are essentially hand-held, high performing small computers. PMEDs are used to do everything from check email, browse the Internet, launch entertainment and much more. Typically, PMEDs have a touchscreen, keyboards or physical buttons for user interface and interactions. PMEDs connect to communication networks such as Internet, Wi-Fi, Bluetooth, cellular networks or near field communication (NFC) networks to stream data. A number of PMEDs also have the storage capacity to store and display video games, videos, and the like. For these and other reasons, understandably, users of PMEDs become very attached, and invested in their units.

When users find themselves in circumstances where the user will be seated or reclined for extended periods of time in armed accommodations, as in a barber's chair, a wheel chair, an infant stroller, an infant's high-chair, a baby's walker, a child's car seat, an armed spa chair, an armed dentist's chair, an armed hospital bed, armed airport seating, armed stadium seating, airplane seating, or the like, holding a PMED becomes contrary, impactable, and in some instances impossible. Therefore, a need exists for providing a PMED support device which is hands-free, stable, and adjustable so that a PMED user can continue to view, interact and interface with the PMED without disruption to the principle activity or service. Solutions have been attempted in the past, see for example US 2009/0060473 A1 (hereinafter '473), however, '473 teaches a support device having a flexible single arm or shaft. Such a solution would not present a satisfactory solution to the user who is in an armed accommodation such as sitting in a chair or is situated in a reclined position, and either the armed accommodation or the user will need to move from time to time. In this instance, having one shaft that is flexible does not provide a stable support in that circumstance. Furthermore, in situations where a user is required to “face forward” while seated or laying in an armed accommodation due to constraints in space or circumstances, the requirements of using a device with one shaft that can mount only onto one arm of the armed accommodation becomes contrary, impactable, and in some instances impossible altogether, and may cause the user's neck some discomfort due to strain.

### SUMMARY OF THE INVENTION

The present invention is a personal mobile electronic device support apparatus that provides for hands-free viewing, interaction, and interface by a user when seated or reclined.

The present invention is configured to attach to most any armed-accommodation such as, but not limited to a barber's chair, a wheel chair, an infant stroller, an infant's high-chair, a baby's walker, a child's car seat, an armed spa chair, an armed dentist's chair, an armed hospital bed, armed airport seating, armed stadium seating, airplane seating, and the like.

An object of the present invention is to provide a user with the ability to utilize the hands-free viewing of a mobile device while in a reclined, comfortable, and unobstructed viewing position.

An object of the present invention is to equidistantly attach to armed accommodation surfaces.

An object of the present invention is to provide a mobile device support apparatus comprising:
a stabilizing unit, wherein the stabilizing unit comprises a first side and second side, the stabilizing unit further comprises a mobile device securing means, wherein the mobile device securing means is connectedly engaged with, and positioned at the center of the stabilizing unit;
a first support arm and a second support arm, wherein each first and second support arm has a proximate end and a distal end, and wherein the distal end of the first support arm is configured to attach to the first side of the stabilizing unit, and the distal end of the second support arm is configured to attach to the second side of the stabilizing unit; and
a first clamping means and second clamping means, wherein the proximate end of the first support arm is connectedly engaged to the first clamping means, and the proximate end of the second support arm is connectedly engaged to the second clamping means.

An object of the present invention is to provide a mobile device securing means that is configured to receive a mobile device adapter.

An object of the present invention is to provide a mobile device securing means that is configured to receive a mobile device.

An object of the present invention is to provide a stabilizing unit that is adjustable.

An object of the present invention is to provide a clamping means configured to securedly engage an armed accommodation.

An object of the present invention is to provide a stabilizing unit that is adjustable along an x-axis.

An object of the present invention is to provide a stabilizing unit that is fixed.

An object of the present invention is to provide a first support arm that is fixed.

An object of the present invention is to provide a first support arm that is adjustable along an x-axis.

An object of the present invention is to provide a first support arm that is adjustable along a y-axis.

An object of the present invention is to provide a first support arm that is telescoping.

An object of the present invention is to provide a first support arm that is non-flexible.

An object of the present invention is to provide a first support arm that is configured to pivot.

An object of the present invention is to provide a second support arm that is fixed.

An object of the present invention is to provide a second support arm that is adjustable along an x-axis.

An object of the present invention is to provide a second support arm that is adjustable along a y-axis.

An object of the present invention is to provide a second support arm that is telescoping.

An object of the present invention is to provide a second support arm that is non-flexible.

An object of the present invention is to provide a second support arm that is configured to pivot.

An object of the present invention is to provide a first support arm and a second support arm which attach to the stabilizing unit at equidistant points as measured from the center of the stabilizing unit.

An object of the present invention is to provide a clamping means which is selected from the group consisting of spring-loaded clamps, alligator clips, plier-style clips, center spring clips, hybrid clips, and crocodile clips.

An object of the present invention is to provide a mobile device support apparatus kit comprising:
a stabilizing unit, wherein the stabilizing unit comprises a first side and second side and the stabilizing unit further comprises a mobile device securing means, wherein the mobile device securing means is connectedly engaged with, and positioned at the center of the stabilizing unit;
a first support arm;
a second support arm;
a first clamping means;
a second clamping means; and
an optional mobile device adapter.

Definitions
The term “proximate end” means the end situated closest toward the stabilizing unit.
The term “distal end” means the end situated furthest away from the stabilizing unit.
The term “adjustable” means the manner in which the component operates or is secured may be adjusted.
The term “fixed” means to be rigidly secured.
The term “telescoping” means to slide or cause to slide into itself, so that a component becomes smaller or larger; or alternatively longer or shorter.
The term “non-flexible” means incapable of being bent or flexed.
The term “pivot” means the central point, pin, or shaft on which a mechanism turns or oscillates.
The term “armed accommodation” includes, but is not limited to a chair or other seating or reclining apparatus having two arms or rails generally equidistant apart including but not limited to a barber's chair, a wheel chair, an infant or child's stroller, an infant or child's high-chair, a baby's walker, a child's car seat, an armed spa chair, an armed dentist's chair, an armed hospital bed, armed airport seating, armed stadium seating, airplane seating, or the like.

### BRIEF DESCRIPTION OF THE FIGURES

FIG. 1 is a front perspective view of an embodiment of the invention as attached to a barber's chair.

FIG. 2 is a left perspective view of an embodiment of the invention as attached to a barber's chair.

FIG. 3 is a left perspective view of an embodiment of the invention in use by a child seated in a barber's chair.

FIG. 4 is a front view of an embodiment of the invention.

FIG. 5 is a rear view of an embodiment of the invention.

FIG. 6 is a right perspective view of an embodiment of the invention as attached to a barber chair.

FIG. 7 is a front view of an embodiment of the invention as attached to a barber's chair.

FIG. 8 is a left perspective view of an embodiment of the invention as attached to a barber's chair.

FIG. 9 is a left perspective view of an embodiment of the invention as attached to a baby's car seat.

FIG. 10 is a left perspective view of an embodiment of the invention as attached to a baby's stroller.

FIG. 11 is a left perspective view of an embodiment of the invention as attached to a baby's car seat.

FIG. 12 is a top view of an embodiment of the invention unattached to an armed accommodation.

### DETAILED DESCRIPTION OF THE INVENTION

The description that follows is presented to enable one skilled in the art to make and use the present invention, and is provided in the context of a range of embodiments and applications. Various modifications to the disclosed embodiments will be apparent to those skilled in the art, and the general principles discussed below may be applied to other embodiments and applications without departing from the scope and spirit of the invention. Therefore, this disclosure of the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended sole for efficiency and ease of understanding the present invention, and are not to be construed as limiting in any way, or as implying that the various embodiments themselves are identical.

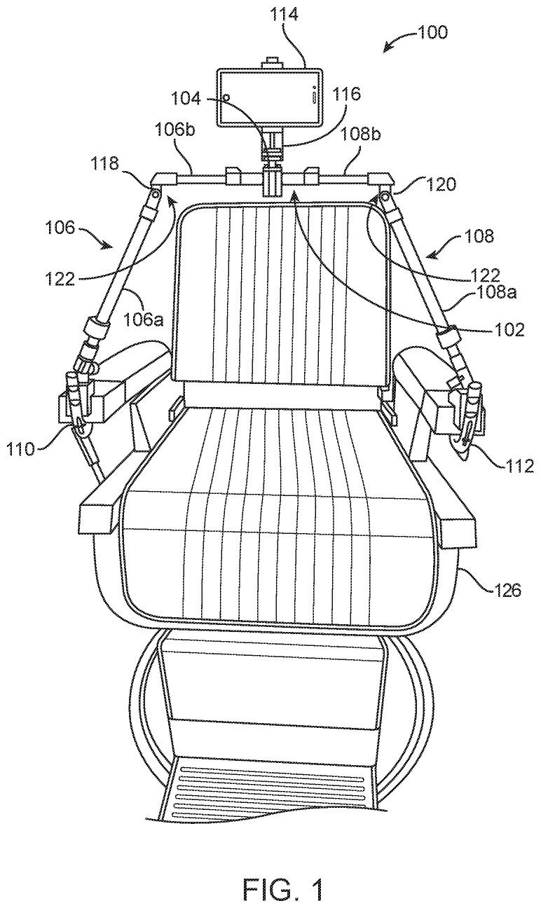

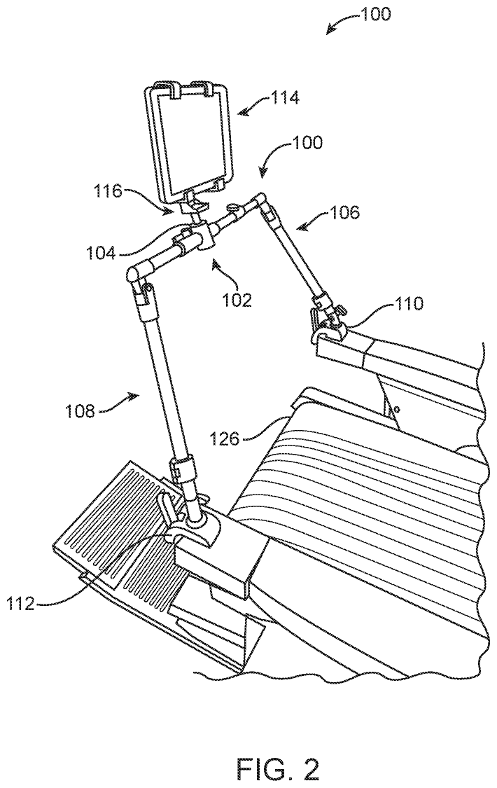

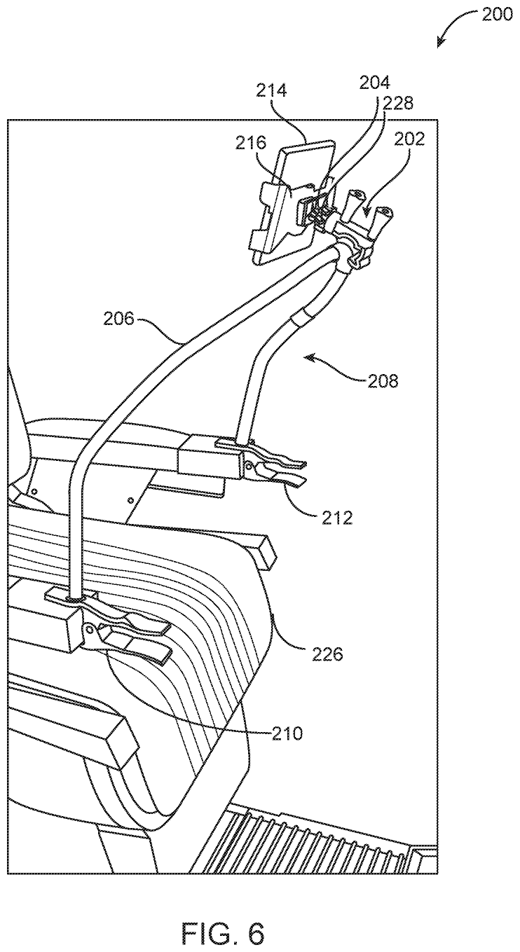

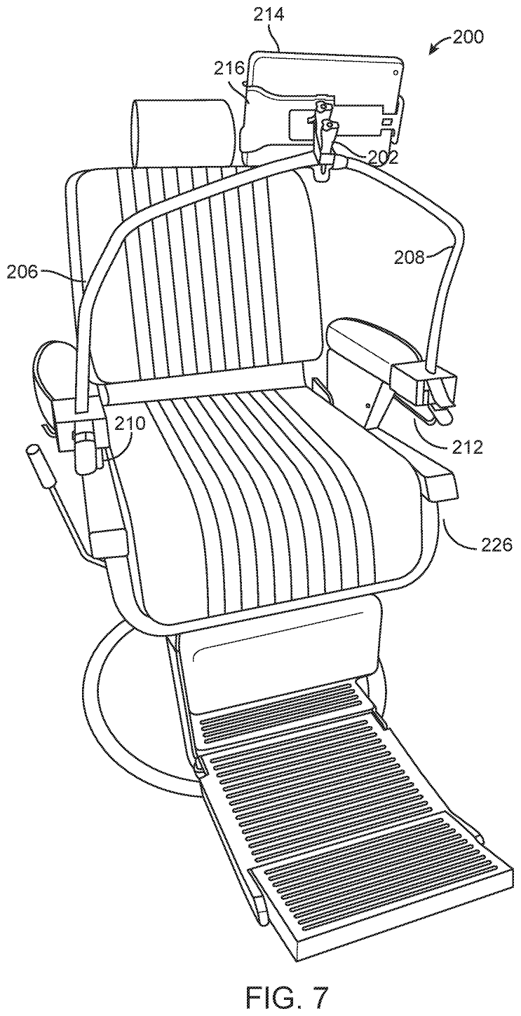

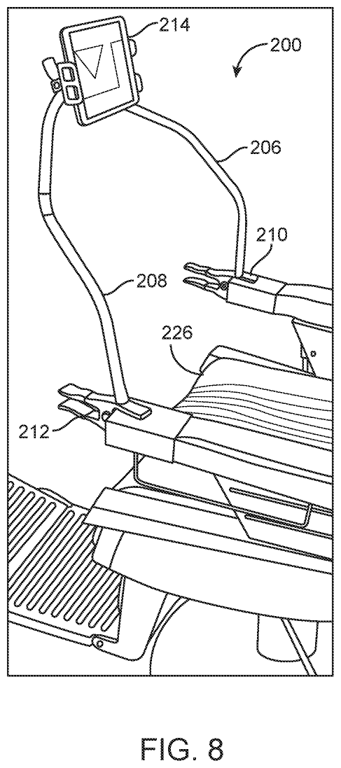

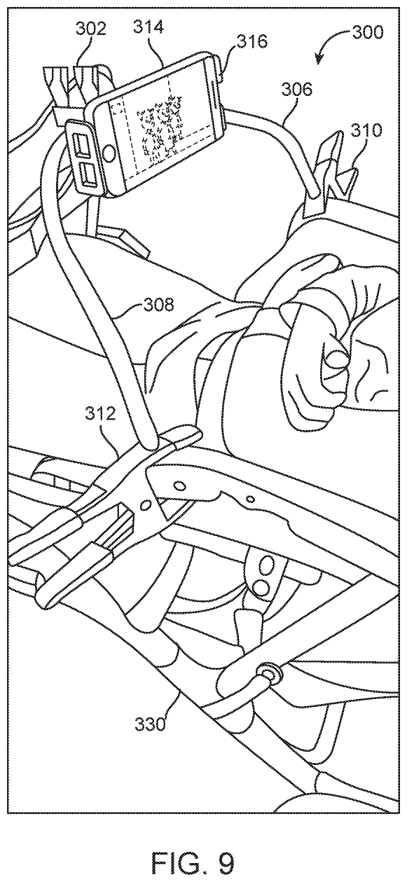

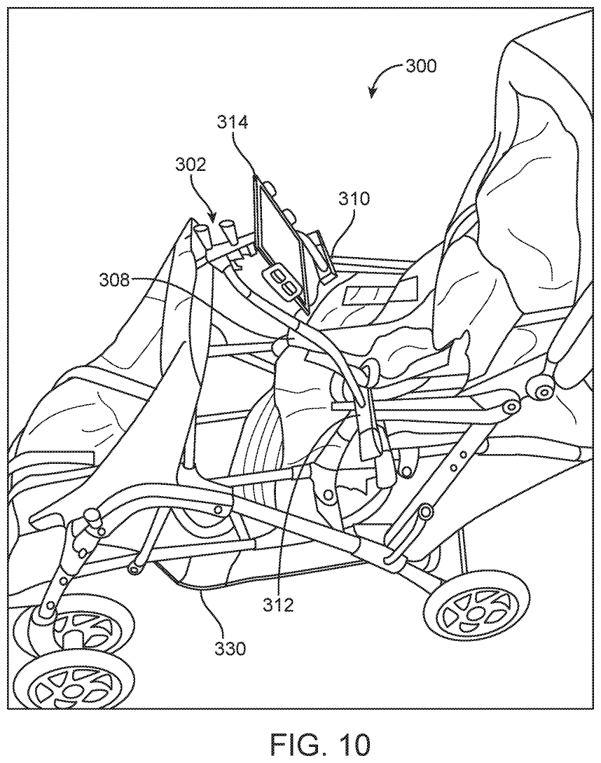

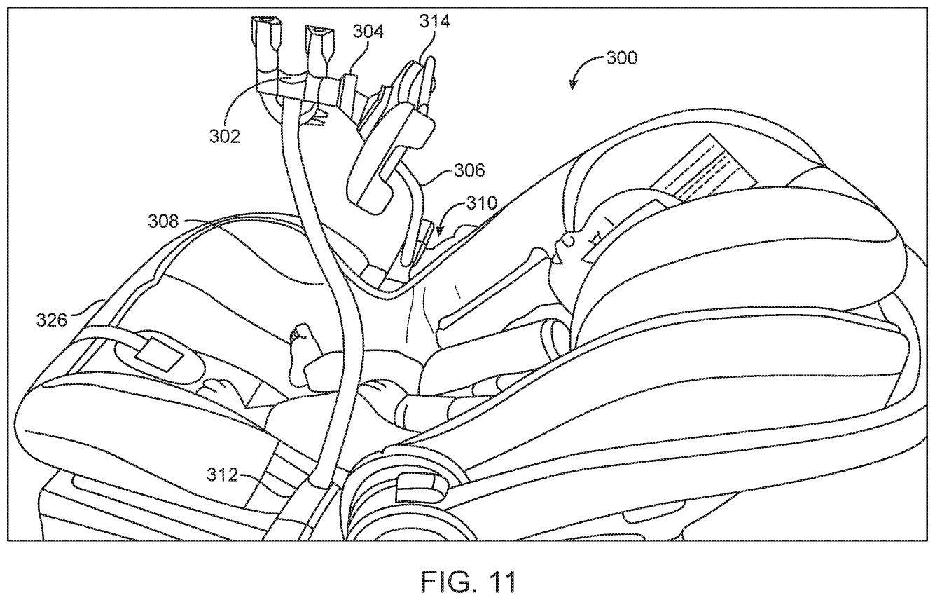

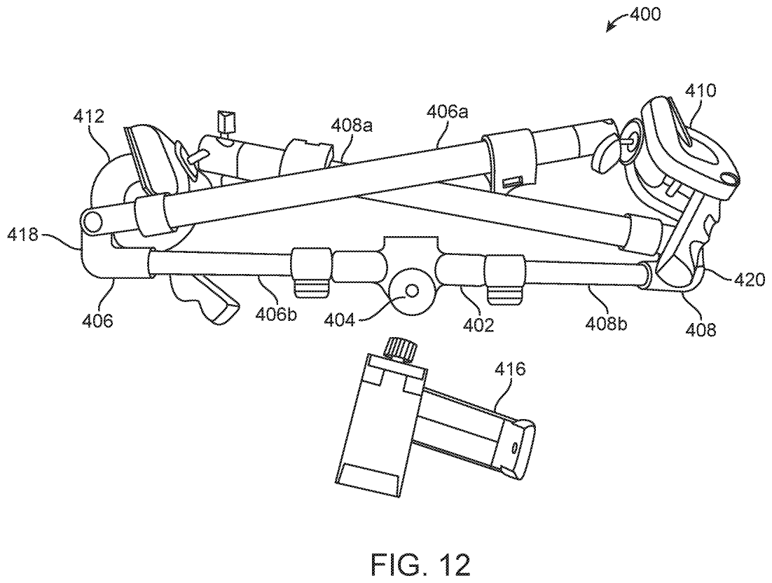

Embodiments of the invention are illustrated in FIG. 1-FIG. 12 providing a mobile device support apparatus 100, 200, 300, 400. FIG. 1-FIG. 4 provide an embodiment of the invention having a stabilizing unit 102 with a first side and a second side, whereupon support arms 106, 108 can be adjustably sized in support of a variety of armed accommodations and PMEDs such as for example mobile tablets, such as an iPad® (iPad is a registered trademark of Apple, Inc.), cell phones, such as for example an iPhone®(iPhone is a registered trademark of Apple, Inc.), or the like. In yet another embodiment of the invention, FIG. 6-FIG. 8 provides a stabilizing unit 202 with a first side and a second side, whereupon fixed support arms 206, 208 can be used in support of a variety of armed accommodations and PMEDs. Yet another embodiment of the invention, FIG. 9, FIG. 10, and FIG. 11 provides a stabilizing unit 302 with a first side and a second side, whereupon fixed support arms 306, 308 can be used in support of a variety of armed accommodations and PMEDs. In yet another embodiment of the invention, FIG. 12 provides a stabilizing unit 402 with a first side and a second side, whereupon support arms 406, 408 can be adjustably sized in support of a variety of armed accommodations and PMEDs.

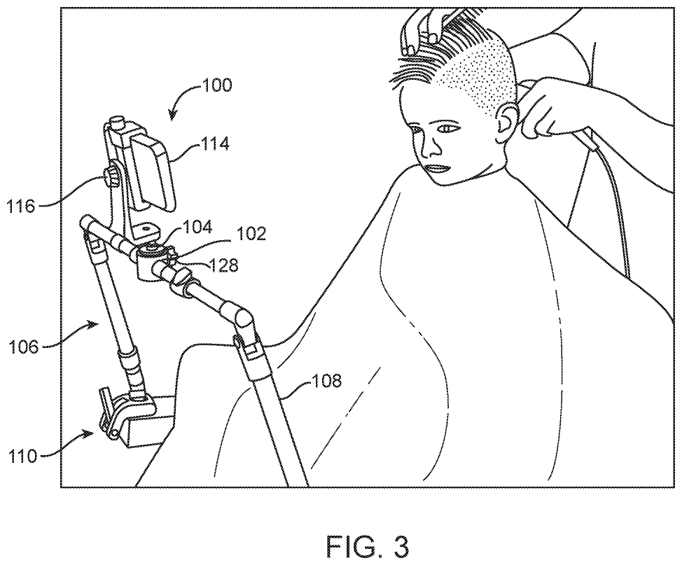

FIG. 1-FIG. 12 provide an embodiment of the invention having a stabilizing unit 102, 202, 302, 402 where a mobile securing means 104, 204, 304, 404 is connectedly engaged therewith, and positioned at the center of the stabilizing unit 102, 202, 302, 402. FIG. 3 and FIG. 6 provide an embodiment of the invention having a stabilizing unit adjustment means 128, 228 which enables the stabilizing unit 102, 202 to be adjustable. The stabilizing unit adjustment means 128, 228 can be used to adjust the stability and security of a mobile device 114, 214 onto the apparatus 100, 200. The stabilizing unit adjustment means 128, 228 can be constructed of any suitable material known to one of reasonable skill in art such as aluminum, plastic, or a combination thereof for example.

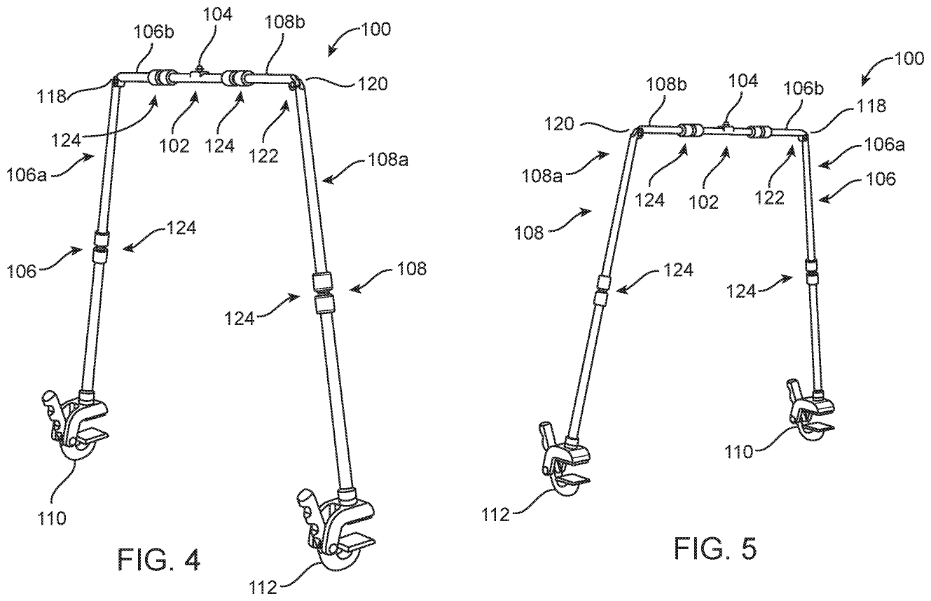

A first support arm 106, 206, 306, 406 and a second support arm 108, 208, 308, 408 can be connected to the stabilizing unit 102, 202, 302, 402 on a first side and a second side of the stabilizing unit 102, 202, 302, 402 respectively, and can connect to the stabilizing unit at equidistant points as measured from the center of the stabilizing unit. FIG. 1-FIG. 5, and FIG. 12 provide an embodiment of the invention having support arms 106, 406; 108, 408 which are adjustable about a telescoping point 124, a pivot point 122, a first support arm pivot 118, 418, and second support arm pivot 120, 420. The pivot and telescoping points allow the apparatus to articulate about the x-axis and y-axis and stably adjust the width and height of the apparatus to fit the width and height of the armed accommodation without breaking. FIG. 6-FIG. 11 provide embodiments where the apparatus 200, 300 provides support arms 206, 208; 306, 308 which are fixed. FIG. 1, FIG. 4, FIG. 5, and FIG. 12 provide an embodiment of the invention having support arms 106, 108, 406, 408 which can be further characterized into upper and lower support arms. Consequently, the first support arm 106, 406 can have a first support arm lower 106a, 406a and a first support arm upper 106b, 406b. And likewise, the second support arm 108, 408 can have a second support arm lower 108a, 408a and a second support arm upper 108b, 408b. The support arms 106, 108, 406, 408 can have a proximate end and distal end. The distal end of the first support arm 106, 406 is configured to attach to the first side of the stabilizing unit 102, 402 and the distal end of the second support arm 108, 408 is configured to attach to the second side of the stabilizing unit 102. In some embodiments, the first support arm upper 106b, 406b is the distal end that attaches to the first side of the stabilizing unit 102, 402; and the second support arm upper 108b, 408b is the distal end that attaches to the second side of the stabilizing unit 102, 402.

FIG. 1-FIG. 12 provide an embodiment of the invention having a clamping means 110, 112; 210, 212; 310,312; 410, 412 which is connectedly engaged onto the support arms 106, 108; 206, 208; 306, 308; 406, 408 to secure the apparatus onto an armed accommodation such as for example a chair 126, 226, a car seat 326, or a stroller 330 to name a few. An embodiment of the invention provides a first clamping means 110, 210, 310, 410 and a second clamping means 112, 212, 312, 412. The first clamping means 110, 210, 310, 410 is connectedly engaged onto the proximate end of the first support arm 106, 206, 306, 406; and the second clamping means 112, 212, 312, 412 is connectedly engaged onto the proximate end of the second support arm 108, 208, 308, 408. In some embodiments, the first support arm lower 106a, 406a is the proximate end that is connectedly engaged with the first clamping means 110 410; and the second support arm lower 108b, 408b is the proximate end that is connectedly engaged with the second clamping means 112, 412.

FIG. 1-FIG. 12 provide an embodiment of the invention where the apparatus 100, 200, 300, 400 is configured with a mobile device adapter 116, 216, 316, 416 capable of holding a mobile device 114, 214, 314. The mobile device adapter 116, 216, 316, 416 is made from any suitable material known of reasonable skill in the art, such as but not limited to plastic, metal, or the like.

The support arms 106, 108; 206, 208; 306, 308; 406, 408 are preferably non-flexible, such attributes provide a stable support device apparatus when used with an armed accommodation, in particular when used with an armed accommodation which can be mobile and to which the invention is attached is moved. The support arms 106, 108; 206, 208; 306, 308; 406, 408 can be fixed or adjustable. Fixed support arms 106, 108; 206, 208; 306, 308; 406, 408 can provide an increasingly stable support when the armed accommodation to which the invention is attached is moved intentionally such as stroller 330 or car seat 326, or if the accommodation is moved unintentionally (bumped) for example when attached to an air plane seat for example. Depending on the various utilization of various armed accommodations, for example the present invention can utilized with an infant's stroller 330, a dentist chair, an infant's walker, a hospital bed, airport seating, automobile seating, a barber's chair 126, a wheel chair, an infant's high chair, an infant's car seat 326 and the like.

Various dimensions, lengths, widths, heights, thickness, etc. will be critical for the given use. For example, one embodiment provides an invention where the length of the support arms 106, 108; 206, 208; 306, 308; 406, 408 may be between 4.0-30.0 inches; preferably 4.0 inches; more preferably 9.0 inches; more preferably 12.0 inches, more preferably 24.0 inches, and more preferably 30.0 inches. When extended along a y-plane, the length between the support arms 106 and 108; 206 and 208; 306 and 308; 406 and 408 may be between 8.0-30.0 inches; preferably 8.0 inches; more preferably 10.5 inches; more preferably 18.5 inches; more preferably 24 inches; more preferably 30.0 inches. When the support arms 106 and 108; 206 and 208; 306 and 308; 406 and 408 are extended along a y-plane, the length between clamping means 110 and 112; 210 and 212; 310 and 312; 410 and 412 may be between 10.0-50.0 inches; preferably 10.0 inches; more preferably 12 inches; more preferably 20.5 inches; more preferably 24.0 inches; more preferably 32 inches; more preferably 50.0 inches. The support arms 106, 108; 206, 208; 306, 308; 406, 408 are also preferably angled to provide additional stability and support. The support arms 106, 108; 206, 208; 306, 308; 406, 408 can be positioned at a fixed angle, from 10 degrees-90 degree, to provide additional stability and support; or can be positioned about an angle that moves from 10 degrees-90 degrees about the pivot point 122 or about the first support arm pivot 118, 418 or second support arm pivot 120, 420. The stabilizing unit 102, 202, 302, 402 is has a width between 5.0-15.0 inches; preferably 5.0 inches, preferably 8.80 inches, more preferably 10 inches, and more preferably 15 inches. The telescoping point 124, as measured from a fully contracted position, can expand from 0.25 inches-1.0 inch; preferably 0.25 inches, preferably 0.39 inches, more preferably 1.0 inch. The clamping means 110, 112; 210, 212; 310, 312; 410, 412 clamps are capable of opening to a width of between 0.5-2.0 inches; preferably 0.5 inches; more preferably 1.0 inch; more preferably 1.45 inches; more preferably 1.61 inches; more preferably 2.0 inches.

FIG. 1-FIG. 5 and FIG. 12 provide embodiments of the invention where the support arms 106, 108; 406, 408 may be configured to attach to the stabilizing unit 102, 402. The support arms 106, 108; 406, 408 can attach to the stabilizing unit 102, 402 through any means known to those of reasonable skill in the art, such as screw, glue, ball and socket, or magnetization, or the like. FIG. 6-FIG. 11 conversely, provide embodiments of the invention where support arms 206, 208; 306, 308 of invention may be configured to attach to the stabilizing unit 202, 302 by tack, machine, weld, or the like.

Likewise, FIG. 1-FIG. 5 and FIG. 12 provide embodiments of the invention where the support arms 106, 108; 406, 408 may be configured to attach to the clamping means 110, 112; 410, 412 through any means known to those of reasonable skill in the art, such as screw, glue, ball and socket, or magnetization, or the like. FIG. 6-FIG. 11 conversely, provide embodiments of the invention where support arms 206, 208; 306, 308 of invention may be configured to connectedly engage to clamping means 210, 212; 310, 312 by tack, machine, weld, or the like. An embodiment of the invention provides the clamping means 110, 112; 210, 212; 310, 312; 410, 412 can also pivot about an axis to rotate in the plane from 0 to 180 degrees. In yet another embodiment, the clamping means 110, 112; 210, 212; 310, 312; 410, 412 can remain fixed, and non-rotatable.

The clamping means 110, 112; 210, 212; 310, 312; 410, 412, the support arms 106, 108; 206, 208; 306, 308; 406, 408, and the stabilizing unit 102, 202, 302, 402 can be manufactured from any suitable material known to one of reasonable skill in the art, such as aluminum, plastic, non-reactive metal alloys, iron, rubber, steel, or reinforced paper.

Embodiments of the invention provide a clamping means 110, 112; 210, 212; 310, 312; 410, 412 for securing the apparatus 100, 200, 200, 400 onto an armed accommodation such as an infant's stroller 330, a dentist chair, an infant's walker, a hospital bed, airport seating, automobile seating, a barber's chair 126, a wheel chair, an infant's high chair, an infant's car seat 326 or the like by means such as any suitable clamping means 110, 112; 210, 212; 310, 312; 410, 412 such as spring-loaded clamp, alligator clips, plier style clips, center spring clips, hybrid clips, crocodile clips, or the like.

Unless defined otherwise, all technical and scientific terms used herein have the same meaning as commonly understood by one of ordinary skill in the art to which the present invention pertains. Although any methods and materials similar or equivalent to those described herein can be used in the practice or testing of the present invention, the preferred methods and materials have been now herein described.

While the principles of the invention have been made clear in illustrative embodiments, it will be immediately obvious to those skilled in the art many modifications of structure, arrangement, proportions, elements, materials, and components used in the practice of the invention, or otherwise, can be made without departing from the spirit of the disclosed invention.

The appended claims are intended to cover and embrace any and all modifications, with limits only of the true purview, spirit, and scope of the invention.

I claim:

1. A mobile device support apparatus comprising:
a stabilizing unit, wherein the stabilizing unit comprises a first side and second side, the stabilizing unit further comprises a mobile device securing means, wherein the mobile device securing means is connectedly engaged with, and positioned at the center of the stabilizing unit;
a first support arm and a second support arm, wherein each first and second support arm has a proximate end and a distal end, and wherein the distal end of the first support arm is configured to attach to the first side of the stabilizing unit, and the distal end of the second support arm is configured to attach to the second side of the stabilizing unit; and
a first clamping means and second clamping means, wherein the proximate end of the first support arm is connectedly engaged to the first clamping means, and the proximate end of the second support arm is connectedly engaged to the second clamping means.

2. The apparatus of claim 1, wherein the mobile device securing means is configured to receive a mobile device adapter.

3. The apparatus of claim 1, wherein the stabilizing unit is adjustable.

4. The apparatus of claim 1, wherein the clamping means configured to securedly engage an armed accommodation.

5. The apparatus of claim 1, wherein the stabilizing unit is fixed.

6. The apparatus of claim 1, wherein the first support arm is fixed.

7. The apparatus of claim 1, wherein the first support arm is adjustable along an x-axis.

8. The apparatus of claim 1, wherein the first support arm is adjustable along a y-axis.

9. The apparatus of claim 1, wherein the first support arm is telescoping.

10. The apparatus of claim 1, wherein the first support arm is non-flexible.

11. The apparatus of claim 1, wherein the first support arm is configured to pivot.

12. The apparatus of claim 1, wherein the second support arm is fixed.

13. The apparatus of claim 1, wherein the second support arm is adjustable along an x-axis.

14. The apparatus of claim 1, wherein the second support arm is adjustable along a y-axis.

15. The apparatus of claim 1, wherein the second support arm is telescoping.

16. The apparatus of claim 1, wherein the second support arm is non-flexible.

17. The apparatus of claim 1, wherein the second support arm is configured to pivot.

18. The apparatus of claim 1, wherein, the first support arm and the second support arm attach to the stabilizing unit at equidistant points as measured from the center of the stabilizing unit.

19. The apparatus of claim 1, wherein the clamping means is selected from the group consisting of spring-loaded clamps, alligator clips, plier-style clips, center spring clips, hybrid clips, and crocodile clips.

20. A mobile device support apparatus kit comprising:
a stabilizing unit, wherein the stabilizing unit comprises a first side and second side and the stabilizing unit further comprises a mobile device securing means, wherein the mobile device securing means is connectedly engaged with, and positioned at the center of the stabilizing unit;
a first support arm;
a second support arm;
a first clamping means;
a second clamping means; and
an optional mobile device adapter.
